(19) United States
(12) Patent Application Publication
(10) Pub. No.: US 2015/0187256 A1
(43) Pub. Date: Jul. 2, 2015

(54) PREVENTING FETCH OF OCCLUDED PIXELS FOR DISPLAY PROCESSING AND SCAN-OUT

(71) Applicant: NVIDIA CORPORATION, Santa Clara, CA (US)

(72) Inventors: Rudi BLOKS, Sunnyvale, CA (US); Sarika Bhimkaran KHATOD, Bangalore (IN); David Matthew STEARS, San Jose, CA (US)

(73) Assignee: NVIDIA CORPORATION, Santa Clara, CA (US)

(21) Appl. No.: 14/146,673

(22) Filed: Jan. 2, 2014

(51) Int. Cl. G09G 3/20; G06T 1/20

(52) U.S. Cl. CPC G09G 3/2092; G06T 1/20; G09G 2340/12; G09G 2330/021

(57) ABSTRACT

One embodiment of the present invention includes techniques for compositing image surfaces to generate a display image for display. A display engine receives a first set of parameters associated with a first image surface stored in a memory. The display engine receives a second set of parameters associated with a second image surface stored in the memory, wherein the second image surface overlaps at least a portion of the first image surface. The display engine selects a first pixel group that is associated with the first image surface and does not contribute visually to the display image. The display engine prevents the first pixel group from being retrieved from the first image surface. One advantage of the disclosed embodiments is that power consumption is reduced and memory performance is improved by preventing retrieval of pixel information that does not contribute to the final visual display transmitted to the display device.

### BACKGROUND OF THE INVENTION

1. Field of the Invention

Embodiments of the present invention relate generally to computer graphics and, more specifically, to preventing fetch of occluded pixels for display processing and scan-out.

2. Description of the Related Art

In computer systems, various application programs may create windows, or image surfaces, for display on a display device such as a computer monitor or projection system. Various windows may overlap with each other, and, accordingly, may obscure each other in whole or in part. Each window includes a depth, or ‘z,’ value that determines whether a given window is visually closer to the surface of the display screen as compared with other windows. A first window that is visually closer to the surface of the display screen than a second window is said to be in front of the second window. Otherwise, the first window is said to be behind the second window.

Each window may have regions that are fully opaque, fully transparent, or partially transparent. A fully opaque region of a first window completely blocks picture elements (pixels) that lie in overlapping regions from windows that are behind the first window. A fully transparent region of a first window is invisible, revealing pixels that lie in overlapping regions from windows that are behind the first window. A partially transparent region of a first window partially obscures pixels in overlapping regions from windows that are behind the first window. To display the various windows on the display device, each window is retrieved and then written, or “composited,” into a display memory. Typically, a scan-out engine then retrieves pixel data from the display memory and transmits the pixel data to a display device via a standard protocol such as high-definition multimedia interface (HDMI) or displayport (DP) for visual display.

One drawback to the above approach is that where overlapping windows include fully transparent or fully opaque regions, some of the pixel information retrieved in these overlapping regions does not contribute to the final pixel values written to the display memory. Retrieving such pixel information from memory consumes power and memory bandwidth. As a result, power and memory bandwidth is consumed for retrieving pixel information that is not seen in the final visual display, resulting in shorter battery life and reduced memory performance.

Accordingly, what is needed in the art is a more efficient approach to composite windows into a display memory.

### SUMMARY OF THE INVENTION

One embodiment of the present invention sets forth a method for compositing image surfaces to generate a display image for display. The method includes receiving a first set of parameters associated with a first image surface stored in a memory. The method further includes receiving a second set of parameters associated with a second image surface stored in the memory, wherein the second image surface overlaps at least a portion of the first image surface. The method further includes selecting a first pixel group that is associated with the first image surface and does not contribute visually to the display image. The method further includes preventing the first pixel group from being retrieved from the first image surface.

Other embodiments include, without limitation, a computer-readable medium that includes instructions that enable a processing unit to implement one or more aspects of the disclosed methods. Other embodiments include, without limitation, a subsystem that includes a processing unit configured to implement one or more aspects of the disclosed methods as well as a system configured to implement one or more aspects of the disclosed methods.

One advantage of the disclosed approach is that power consumption is reduced and memory performance is improved by preventing retrieval of pixel information that does not contribute to the final visual display transmitted to the display device. Retrieval of unneeded pixel data may be prevented even where a window created by one device driver, such as a graphics display driver, is covered by a window created by a different device driver, such as a video display driver.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of the system memory and a parallel processing unit (PPU) in the parallel processing subsystem of FIG. 1, according to one embodiment of the present invention;

FIG. 3 is a block diagram of the display engine in the parallel processing subsystem of FIG. 2, according to one embodiment of the present invention;

FIG. 4 illustrates a portion of a display memory that includes a set of windows, according to one embodiment of the present invention;

FIG. 5A-5C illustrate a source window set, a composition window set, and a modified source window set, according to various embodiments of the present invention; and

FIGS. 6A-6B set forth a flow diagram of method steps for compositing image surfaces into a display memory associated with a display device, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

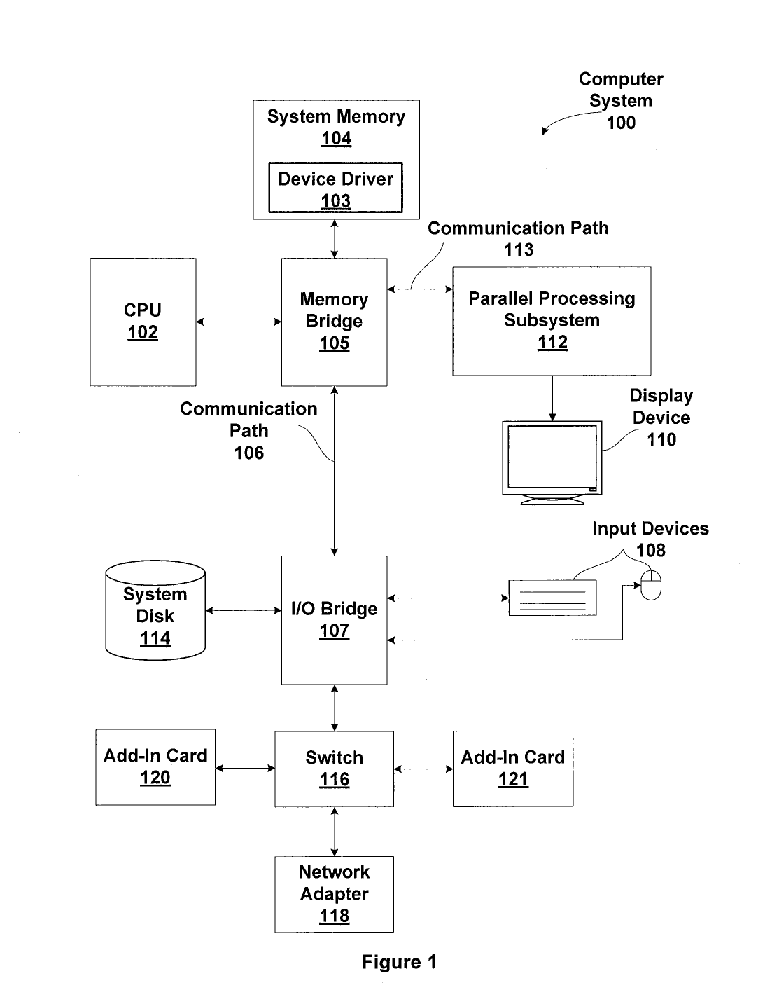

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. Such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

### Preventing Fetch of Occluded Pixels for Display Processing and Scan-Out

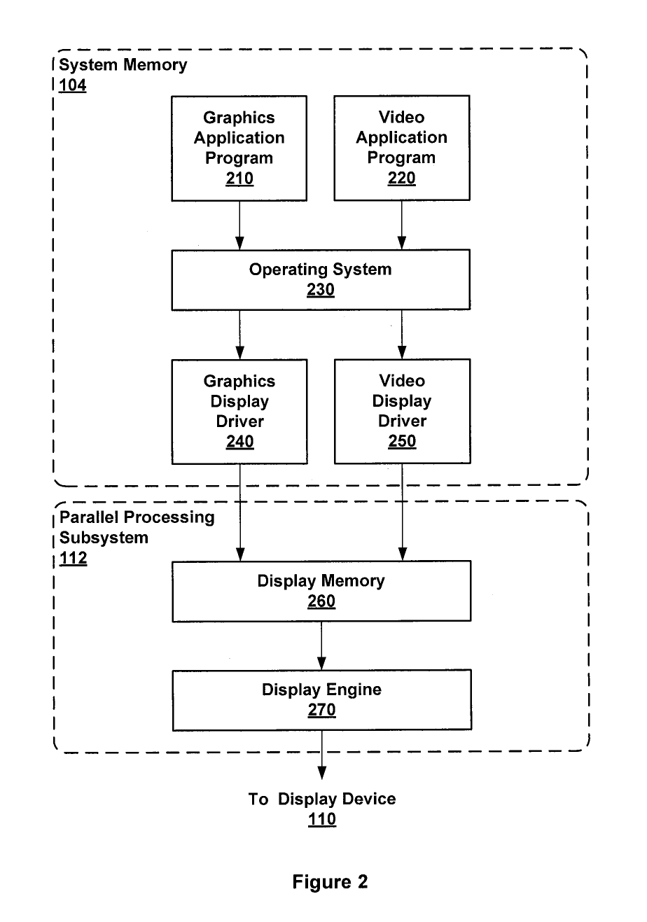

FIG. 2 is a block diagram of the system memory 104 and a parallel processing unit (PPU) 205 in the parallel processing subsystem 112 of FIG. 1, according to one embodiment of the present invention. As shown, the system memory 104 includes a graphics application program 210, a video application program 220, an operating system 230, a graphics display driver 240, and a video display driver 250.

As also shown, the parallel processing unit 205 includes a display memory 260 and a display engine 270. The parallel processing subsystem 112 of FIG. 1 may include any number of PPUs, where each PPU may comprise a graphics processing unit (GPU) that may be configured to implement a graphics rendering pipeline to perform various operations related to generating pixel data based on graphics data supplied by CPU 102 and/or system memory 104.

The graphics application program 210 is a software application program that includes a component that renders two-dimensional (2D) or three-dimensional (3D) graphics objects into a graphics window within a window memory that is subsequently displayed on the display device 110 of FIG. 1. The graphics application program 210 may be stored in system memory 104 and executed by the CPU 102 of FIG. 1. The graphics application program 210 may render the 2D or 3D graphics objects into window memory using a source domain defined by the graphics application program 210. This source domain may be scaled horizontally and vertically to a composition domain suitable for display on the display device 110. The graphics application program 210 may define one or more regions of the graphics window that are fully opaque. The graphics application program 210 may also define one or more regions of the graphics window that are fully transparent. The graphics application program 210 transmits information corresponding to the graphics window, including information regarding fully opaque and fully transparent regions, to the operating system 230 via a graphics applications programming interface (API).

The video application program 220 is a software application program that includes a component that renders video objects into a video window within a window memory that is subsequently displayed on the display device 110 of FIG. 1. The rendered video from the video application program 220 may be from any technically feasible source, including, without limitation, a video file stored on system disk 114, a streaming video signal received by the network adapter 118, or a video signal received from an add-in card 120 121. The video application program 220 may be stored in system memory 104 and executed by the CPU 102 of FIG. 1. The video application program 220 may render the video objects into window memory using a source domain defined by the video application program 220. This source domain may be scaled horizontally and vertically to a composition domain suitable for display on the display device 110. The video application program 220 may define one or more regions of the video window that are fully opaque. The video application program 220 may also define one or more regions of the video window that are fully transparent. The video application program 220 transmits information corresponding to the video window, including information regarding fully opaque and fully transparent regions, to the operating system 230 via a video API.

The operating system 230 receives information from the graphics application program 210 corresponding to the rendered graphics window. Likewise, the operating system 230 receives information from the video application program 220 corresponding to the rendered video window. This information regarding the rendered graphics window and the rendered video window may include information regarding fully opaque and fully transparent regions of the respective windows. The operating system 230 transmits information corresponding to the graphics window, including information regarding fully opaque and fully transparent regions, to the graphics display driver 240 via a graphics display API. Likewise, the operating system 230 transmits information corresponding to the video window, including information regarding fully opaque and fully transparent regions, to the video display driver 250 via a video display API.

In some embodiments, the operating system 230 may include a graphics component (not shown) that receives API function calls from the graphics application program 210. This graphics component may process such graphics API function calls and may transmit corresponding function calls to the graphics display driver 240. Likewise, the operating system 230 may include a video component (not shown) that receives API function calls from the video application program 220. This video component may process such video API function calls and may transmit corresponding function calls to the video display driver 250.

The graphics display driver 240 receives graphics related function calls from the operating system 230, including graphics function calls relayed from the graphics application program 210. Such function calls may include information corresponding to one or more graphics windows, including information regarding fully opaque and fully transparent regions within such graphics windows. In general, the graphics display driver 240 does not have access to information corresponding to video windows, including related fully opaque and fully transparent regions within such video windows. The graphics display driver 240 may be implemented as part of the device driver 104 of FIG. 1 or may be implemented as a separate driver. The graphics display driver 240 processes such function calls and stores corresponding graphics window information in the display memory 260, also referred to as “window memory,” for retrieval and further processing by the display engine 270.

The video display driver 250 receives video related function calls from the operating system 230, including video function calls relayed from the video application program 220. Such function calls may include information corresponding to one or more video windows, including information regarding fully opaque and fully transparent regions within such video windows. In general, the video display driver 250 does not have access to information corresponding to graphics windows, including related fully opaque and fully transparent regions within such graphics windows. The video display driver 250 may be implemented as part of the device driver 104 of FIG. 1 or may be implemented as a separate driver. The video display driver 250 processes such function calls and stores corresponding video window information in the display memory 260, for retrieval and further processing by the display engine 270.

The display memory 260 stores the windows processed by the graphics display driver 240 and the video display driver 250. The display memory 260 is read multiple times per second by the display engine 270 at a rate matching the refresh rate of the display device 110. The data read from the display memory 260 is transmitted to the display device 110. Once the data in the display memory 260 for a given display frame is transmitted to the display device 110, the graphics display driver 240 and the video display driver 250 may write processed images for a subsequent display frame to the display memory 260. The display memory 260 may have one, two, or more display frame buffers, such that the data in one buffer of the display memory 260 is transmitted to the display device 110 at the same time that the graphics display driver 240 and the video display driver 250 stores processed windows into one or more other buffers in the display memory 260.

The display engine 270 retrieves windows that have been rendered and stored in display memory 260 by the graphics display driver 240 and the video display driver 250. The display engine 270 may perform various operations on the rendered windows. For example, the display engine 270 could scale the rendered windows from a source domain to a composition domain. The display engine 270 could scale a rendered window by the same percentage in the horizontal and vertical dimension, preserving the aspect ratio of the original rendered window. Alternatively, the display engine 270 could scale a rendered window by one percentage in the horizontal dimension and a different percentage in the vertical dimension. In another example, the display engine 270 could perform other operations on the rendered windows, including, without limitation, depth-based blending and clipping, color keying, color conversion, and gamma correction.

In one embodiment, the display engine 270 composes windows processed by the graphics display driver 240 and the video display driver 250 on the fly without the use of a display memory 260. In such an embodiment, the display engine 270 processes the windows, and associated pixel data, in parallel, in order that pixel data may be timely transmitted to the display device 110 without interrupting the visual display.

The display engine 270 may perform these functions once for every display frame that is displayed on the display device 110 at a rate corresponding to the refresh rate of the display device 110. The display engine 270 retrieves or “scans out” the processed windows from the display memory 260 once for every display frame and transmits the retrieved data to the display device 110. Accordingly, the display engine 270 may operate at various frame rates, including, without limitation, 24 frames per/second (fps), 25 fps, 30 fps, 50 fps, or 60 fps. In some embodiments, the display engine 270 may store output data in a scan-out memory not shown) which is then scanned out and transmitted to the display device.

The display engine 270 may synchronize timing of the various graphics and video windows that are asynchronously updated by the graphics application program 210 and the video application program 220, while accounting for areas of overlap among the various windows. As a result, the graphics and video windows are properly displayed on the display device 110. Each window may be arbitrarily sized. For example, one window could be designated as a background window that is sized to occupy all or essentially all of the screen space represented in the display memory 260. Other windows could be sized and positioned to occupy a portion of the screen space, where each window could represent images from a software application program, such as the graphics application program 210 or the video application program 220. Windows could also represent various other items including, without limitation, icons, pop-up dialog windows, and menu windows.

The display engine 270 may subdivide the screen space of the display device 110 into regions, where each region represents a different portion of the screen space. Accordingly, each region also corresponds to a different portion of the display memory 260. As the display engine 270 composites windows for a given region of the screen space, the display engine 270 determines the set of windows that intersect with that screen space region. The display engine 270 may then determine if one or more of the intersecting windows are associated with a cutout region that fully occupies the screen space region currently being processed. If an intersecting window is associated with a cutout region that fully occupies the current screen space region, then the display engine 270 prevents retrieval of the corresponding portion of the intersecting window. The display engine 270 then retrieves the corresponding portion of each intersecting window, except for those intersecting windows where retrieval is prevented because of a cutout region.

In some embodiments, the display engine retrieves data from window memory in discrete units known as “fetch atoms.” A fetch atom may be defined as a unit of window memory with a given alignment and size. A memory management unit associated with the window memory may efficiently retrieve data from window memory at such an alignment and size. Accordingly, the display engine 270 may alter the starting address and transfer size of a given portion of window memory to conform with an alignment and size of an integral quantity of fetch atoms. In one example, each fetch atom could be sixteen bytes wide by two rows high. The alignment of each fetch item could be aligned such that the address of the leftmost column of each fetch item is a multiple of sixteen bytes, and the address of the top row of each fetch item is a multiple of two.

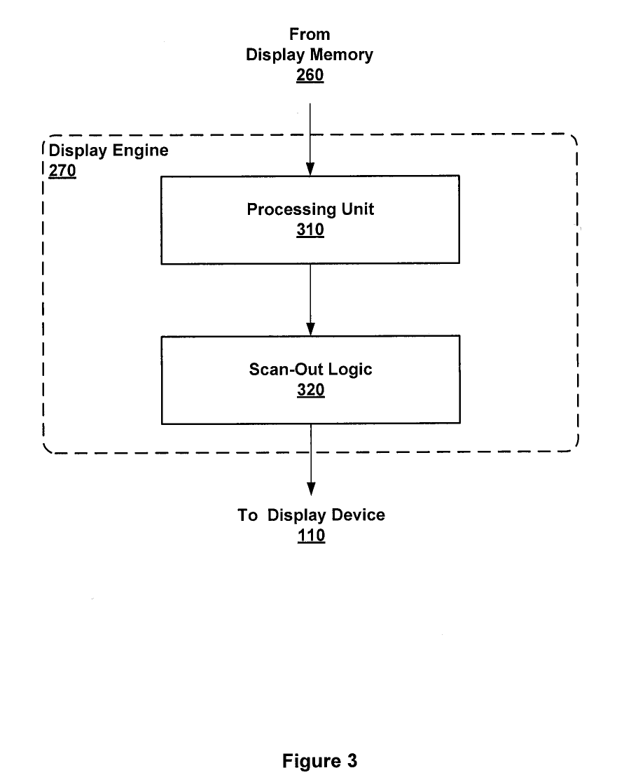

FIG. 3 is a block diagram of the display engine 270 in the parallel processing unit 205 of FIG. 2, according to one embodiment of the present invention. As shown the display engine 270 includes a processing unit 310 and scan-out logic 320

The processing unit 310 is a computing device that performs various windowing functions as described above, including, without limitation, scaling windows, depth-based blending and clipping, color keying, color conversion, gamma correction, and compositing windows. The processing unit also identifies fully opaque and fully transparent regions, generates corresponding cutout regions in one or more corresponding windows, and stores the generated cutout region information for each of the corresponding windows. The processing unit 310 may be implemented using any technically feasible computing device, including, without limitation, a microcontroller, a central processing unit, or a graphics processing unit. As such, the processing unit 310 may execute a display engine application that performs the various operations described herein.

The scan-out logic 320 is a dedicated hardware unit that controls the timing of reading, or scanning out, the display frame data from the display memory 260 and transmission of the display frame data to the display device 110. The scan-out logic 320 may transmit a first timing signal to the processing unit 310 to indicate that scanning of a buffer in the display memory 260 is commencing. Upon receiving this first timing signal, the processing unit 310 may complete one or more outstanding updates and cutout region calculations for a given buffer in the display memory 260 and then cease further updates to the given buffer. The scan-out logic may then scan the given buffer and transmit the data in the given buffer to the display device 110. The scan-out logic 320 may also transmit a second timing signal to the processing unit 310 to indicate when a given buffer within the display memory 260 has been fully transmitted to the display device 110. Upon receiving this second timing signal, the processing unit 310 may write to the given buffer. In embodiments without the display memory, the first timing signal indicates that scanning is commencing for a given state of a set of windows. The second timing signal indicates that scanning is complete for the given state of the set of windows.

It will be appreciated that the architecture described herein is illustrative only and that variations and modifications are possible. In one example, the display engine 270 is described as having a processing unit 310 implemented as a computing device and scan-out logic 320 implemented as a dedicated hardware unit. However, the display engine 270 could be implemented as any technically feasible combination of computing devices and dedicated hardware units. In one example, the display engine 270 could be fully implemented as a computing device executing an application program. In another example, the display engine 270 could be fully implemented as a dedicated hardware unit. In yet another example, the techniques described herein could be implemented by a unified display driver that receives and processes information related to both graphics windows and video windows. In yet another example, any one or more drivers or other software applications may generate windows for processing by the display engine 270, including, without limitation, multiple graphics drivers, a compute driver, the operating system, a video driver, and other sources of window data. In yet another example, windows could be composed outside of a display pipeline by a non-realtime composition engine into a composition memory, and then the resulting composition memory could be scanned out and transmitted to a display device 110.

In some embodiments, a display driver may not be aware of when a particular window state is shown on the display device 110. For example, the graphics display driver 240 could direct the display engine 270 to display a new display window only after a hardware graphics engine has rendered an image into the new display window. In such cases, the graphics display driver 240 would not know when to calculate a cutout for the new window. In such embodiments, even a unified display driver may not be able to compute all the cutout regions without assistance from the display engine 270 described herein.

In another example, the display engine 270 may restrict the quantity of cutout regions, based on the capability of the display engine 270 to timely process the cutout regions. For example, the display engine 270 could restrict the quantity of cutout regions to one cutout region per window. In another example, the display engine 270 could restrict the quantity to four cutout regions total, regardless of the quantity of windows. In such cases, the display engine 270 could determine which cutout regions to keep active and process, based on the cutout regions that result in an optimal level of prevented retrievals. The display engine 270 could update the set of active cutout regions periodically to maintain an optimal level of prevented retrievals. In another example, upon detecting a new window or an update to one or more existing windows, the display engine 270 could invalidate the entries for all active cutout regions, and recomputed cutout regions based on the updated window information. A window that does not have a currently active cutout region would be fully fetched and processed, even if the window has a fully transparent region or is covered, in whole or in part, by a fully opaque region of another window.

In yet another example, the windows depicted herein are rectangular in shape. However, the techniques described herein could be applied to windows that are arbitrary in shape, including, without limitation, windows with a polygonal, elliptical, or irregular shape. In yet another example, the display engine 270 could detect if no window updates are processed between a given display frame and a subsequent display frame. In such cases, the display engine 270 would reuse the computed window and cutout information from the given display frame without repeating the computations for the subsequent display frame, resulting in further power reduction and performance increase.

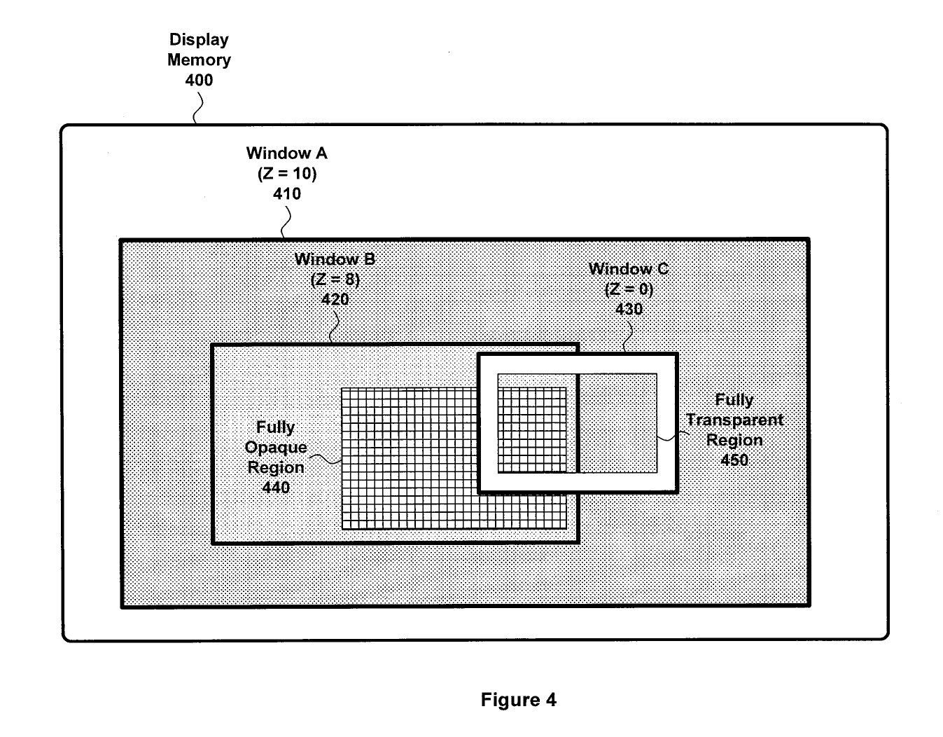

FIG. 4 illustrates a portion of a display memory that includes a set of windows 400, according to one embodiment of the present invention. As shown, the set of windows 400 includes window A 410, window B 420, and window C 430.

Window A 410 is a fully opaque window in the set of windows 400. As shown, window A is behind two other windows: window B 420 and window C 430.

Window B 420 is a window in the set of windows 400 that is in front of window A 410 and behind window C 430. Window B 420 includes a fully opaque region 440. The fully opaque region 440 of window B 420 completely covers the portion of window A 410 that overlaps with the fully opaque region 440. The portion of window B 420 outside of the fully opaque region 440 is partially transparent. This partially transparent region partially covers the portion of window A 410 that overlaps with the partially transparent region. Accordingly, pixels in the display memory 260 in the partially transparent region are written with values that represent a blend of the corresponding pixels of window A 410 and window B 420. As such, the display engine 270 may prevent retrieval of pixels from window A 410 in the region of the window A 410 that overlaps with the fully opaque region 440. However, the display engine 270 may not prevent retrieval of pixels from window A 410 in the region of the window A 410 that overlaps with the partially transparent region of window B 420.

Window C 430 is a window in the set of windows 400 that is in front of both window A 410 and window B 420. Window C 430 includes a fully transparent region 450. The fully transparent region 450 of window C 430 completely reveals the portion of window A 410 and window B 420 that overlaps with the fully transparent region 450. The portion of window C 430 outside of fully transparent region 450 is fully opaque. This fully opaque region completely covers the portion of window A 410 and window B 420 that overlaps with the fully opaque region. Accordingly, pixels in the display memory 260 in the fully opaque region are written with values that represent only the pixels from window C 430. As such, the display engine 270 may prevent retrieval of pixels from window C 430 in the fully transparent region 450 of window C 430. The display engine 270 may also prevent retrieval of pixels from window A 410 and window B 420 in the region that overlaps with the fully opaque region of window C 430.

A depth, or ‘Z,’ value is assigned to each window. Window compositing order may proceed in depth order, where the display engine 270 first processes the window that has the highest Z value, indicating that the window is associated with the window that is furthest away from the screen surface. The display engine 270 progressively processes each window in order of decreasing Z value. Accordingly, the last window processed by the display engine 270 is the window that has the lowest Z value, indicating that the window is associated with the window that is closest to the screen surface. Where two windows overlap, the window with the lower Z-value covers the window with the higher Z-value in the overlapping region. If two windows have exactly the same Z-value, then the two windows are typically prevented from overlapping.

As shown, window A 410, window B 420, and window C 430 have Z-values of 10, 8, and 0, respectively. Accordingly, the display engine 270 processes window A 410 first, followed by window B 420, and finally window C 430. Alternatively, the display engine 270 processes window A 410, window B 420, and window C 430 simultaneously and performs a single multiple-input composition performed per pixel just in time for scanning out to the display device 110. If window B 420 was fully opaque, then window B 420 would completely cover those portions of window A 410 where window B 420 overlaps with window A 410. If window C 430 was likewise fully opaque, then window C 430 would completely cover those portions of window A 410 and window B 420 where window C 430 overlaps with window A 410 and window B 420, respectively.

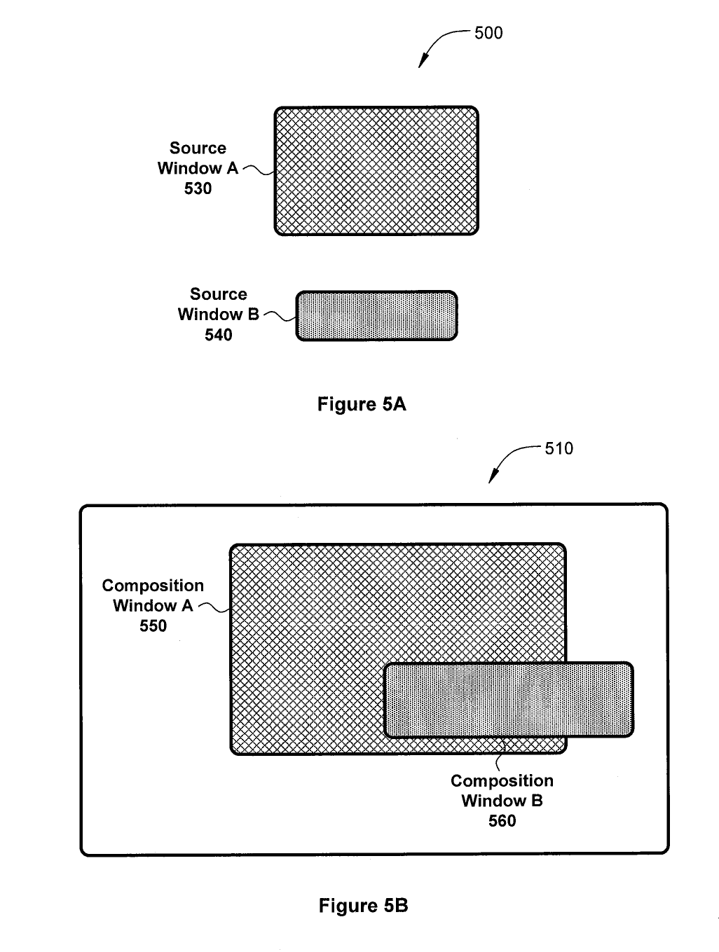

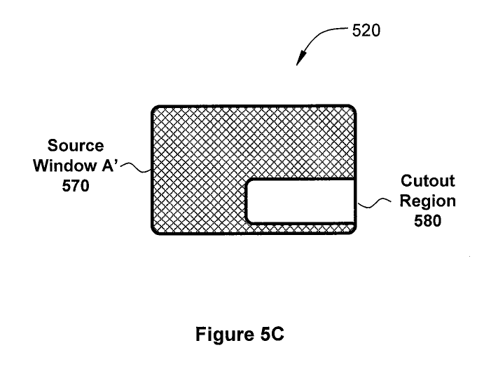

FIG. 5A-5C illustrate a source window set 500, a composition window set 510, and a modified source window set 520, according to various embodiments of the present invention.

As shown in FIG. 5A, the source window set 500 includes source window A 530 and source window B 540. Source window A 530 is a window created by the graphics application program 210. Source window A 530 represents a window in the source domain of the graphics application program 210. Source window B 540 is a window created by the video application program 220. Source window B 540 represents a window in the source domain of the video application program 220.

As shown in FIG. 5B, the composition window set 510 includes composition window A 550 and composition window B 560. Composition window A 550 is a window corresponding to source window A 530 that the display engine 270 has scaled to the composition domain. Likewise, composition window B 560 is a window corresponding to source window B 540 that the display engine 270 has scaled to the composition domain. The scale factor may be defined as the ratio between the size in source domain and the size in the composition domain. The scale factor for a given window may be different in the horizontal direction versus the vertical direction and may be different for each surface. The scale factor for one window is independent of the scale factor for other windows. As shown, composition window B is fully opaque. As such, the display engine may create a cutout region for composition window A 550 in the area where composition window A 550 and composition window B 560 overlap.

As shown in FIG. 5C, the modified source window set 520 includes a modified source window A′ 570 that includes a cutout region 580. The display engine 270 may scale the cutout region from the composition domain, as shown in FIG. 5B, to the source domain of FIG. 5C, using an inverse of the scale factor from the source domain to the composition domain. The display engine 270 may prevent the pixels from the cutout region 580 of the modified source window A′ 570 from being retrieved when compositing windows into the display memory 260. In some embodiments, the cutout region 580 may be reduced in size to account for multi-tap filters used by the display engine during scaling.

Because of such filters, pixels in the modified source window A′ 570 that are immediately inside the scaled cutout region 580 may contribute to the portion of the display frame that is immediately outside the scaled cutout region 580, and therefore retrieved by the display engine 270. For example, if a source window is scaled to a composition window using an N-tap filter in a given direction, either the horizontal direction or the vertical direction, then the cutout region 580 is reduced in size, or inset, by N/2 pixels in the direction of the filter dimension if N is even, or by (N+1)/2 pixels in the direction of the filter dimension if N is odd.

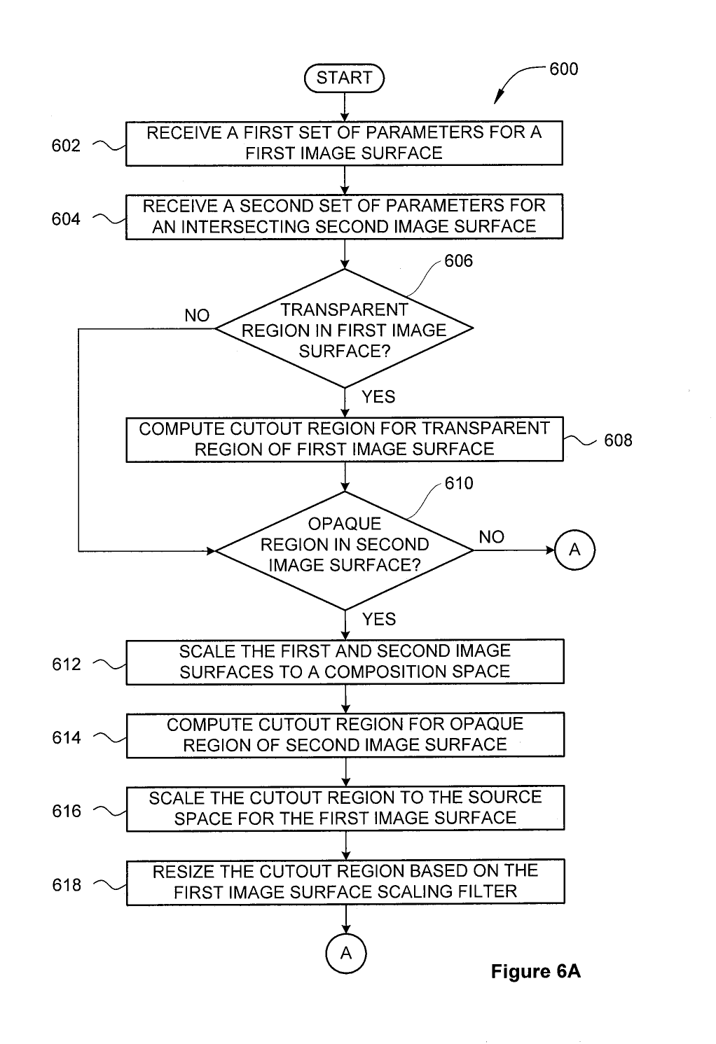

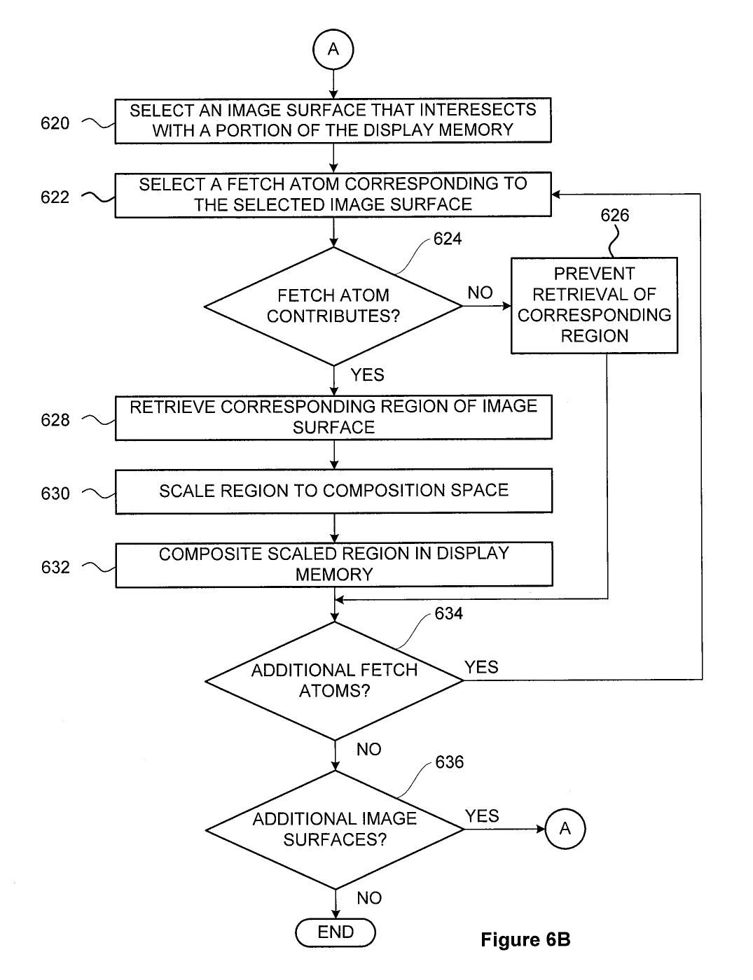

FIGS. 6A-6B set forth a flow diagram of method steps for compositing windows into a display memory associated with a display device, according to one embodiment of the present invention. Although the method steps are described in conjunction with the systems of FIGS. 1-5B, persons of ordinary skill in the art will understand that any system configured to perform the method steps, in any order, is within the scope of the invention.

As shown, a method 600 begins at step 602, where the display engine 270 receives a first set of parameters for a first image surface, or window. At step 604, the display engine 270 receives a second set of parameters for a second image surface, or window. At step 606, the display engine 270 determines whether the first image surface includes a fully transparent region. If the first image surface includes a fully transparent region, then the method 600 proceeds to step 608, where the display engine 270 computes a cutout region corresponding to the fully transparent region of the first image surface.

At step 610, the display engine 270 determines whether the second image surface includes a fully opaque region and has a lower z value than the first image. If the second image surface includes a fully opaque region and has a lower z value than the first image, then the method 600 proceeds to step 612, where the display engine 270 scales the first image surface from a source domain to a composition domain corresponding to the first image surface. Likewise, the display engine 270 scales the second image surface from a source domain to a composition domain corresponding to the second image surface. At step 614, the display engine 270 computes a cutout region corresponding to the fully opaque region of the second image surface. At step 616, the display engine 270 scales the cutout region to the source domain for the first image surface. At step 618, the display engine 270 resizes the cutout region based on a scaling filter for the first image surface.

At step 620, the display engine 270 selects an image surface that intersects with a portion of the display memory 260. At step 622, the display engine 620 selects a fetch atom in the source domain of the selected image surface that corresponds to the intersecting portion of the image surface. At step 624, the display engine 270 determines whether the fetch atom contributes to at least one pixel of the display memory 260. If the fetch atom contributes to at least one pixel of the display memory 260, then the method proceeds to step 628, where the display engine 270 retrieves a region of the selected image surface corresponding to the fetch atom. At step 630, the display engine 270 scales the region represented by the fetch atom to the composition space. At step 632, the display image composites the scaled region represented by the fetch atom into the display memory 260. At step 634, the display engine determines whether additional fetch atoms for the selected image surface remain. If additional fetch atoms remain, then the method 600 proceeds to step 622, described above.

If, however, no additional fetch atoms remain, then the method 600 proceeds to step 636, where the display engine 270 determines whether additional image surfaces remain. If additional image surfaces remain, then the method 600 proceeds to step 620, described above. If, however, no additional image surfaces remain, then the method 600 terminates

Returning to step 624, if the fetch atom does not contribute to any pixel of the display memory 260, then the method proceeds to step 626, where the display engine prevents retrieval of the region of the selected image surface corresponding to the fetch atom. The method 600 then proceeds to step 634, described above.

Returning to step 610, if the second image surface does not include a fully opaque region or does not have a lower z value than the first image, then the method 600 proceeds to step 620, described above.

Returning to step 606, if the first image surface does not include a fully transparent region, then the method 600 proceeds to step 610, described above.

In some embodiments, steps 600-618 are performed in parallel for all image surfaces to calculate cutout regions in pixel order.

In sum, a display engine prevents retrieval of pixel information from window memory where the pixel information does not contribute to the final visual display transmitted to a display device. If a first window includes a fully transparent region, then the display region computes a cutout region corresponding to the fully transparent region, and applies the cutout region to the first window. If a first window includes an overlapping region that is covered by a fully opaque region of a second window, then the display engine computes a cutout region corresponding to the fully opaque region of the second window, and applies the cutout region to the first window. The display engine may compute such cutout regions even for windows generated by different application programs and via different device drivers. The size of the cutout regions may be conservatively reduced in size to account for any scaling filters that may be applied to the windows when scaling the windows from a source domain to a composition domain. When the display engine composites the windows into the display memory, the display engine retrieves potentially visible pixel information from window memory, while preventing retrieval of pixel information corresponding to a cutout region.

One advantage of the disclosed approach is that power consumption is reduced and memory performance is improved by preventing retrieval of pixel information that does not contribute to the final visual display transmitted to the display device. Retrieval of unneeded pixel data may be prevented even where a window created by one device driver, such as a graphics display driver, is covered by a window created by a different device driver, such as a video display driver.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

The invention claimed is:

1. A method for compositing image surfaces to generate a display image for display, the method comprising:
receiving a first set of parameters associated with a first image surface stored in a memory;
receiving a second set of parameters associated with a second image surface stored in the memory, wherein the second image surface overlaps at least a portion of the first image surface;
selecting a first pixel group that is associated with the first image surface and does not contribute visually to the display image; and
preventing the first pixel group from being retrieved from the first image surface.

2. The method of claim 1, further comprising:
scaling the first image surface from a first source domain to a composition domain based on the first set of parameters; and
scaling the second image surface from a second source domain to the composition domain based on the second set of parameters.

3. The method of claim 2, further comprising:
determining that the second image surface resides in front of the first image surface;
computing a cutout region for at least a portion of the composition domain that completely obscures one or more pixels within the portion of the first image surface; and
scaling the cutout region from the composition domain to the first source domain.

4. The method of claim 3, wherein determining that the second image surface resides in front of the first image surface comprises determining that a first depth value associated with the first image surface is greater than a second depth value associated with the second image surface.

5. The method of claim 3, further comprising modifying a dimension of the cutout region based on a scaling filter applied to the first image surface.

6. The method of claim 2, further comprising computing a cutout region for one or more pixels within the portion of the first image surface, wherein the one or more pixels are transparent.

7. The method of claim 1, wherein the first image surface is specified by a first device driver, and the second image surface is specified by a second device driver.

8. The method of claim 7, wherein the first device driver comprises a graphics display driver, and the second device driver comprises a video display driver.

9. The method of claim 1, further comprising:
aligning the first pixel group to conform with an alignment specification of a memory controller; and
sizing the first pixel group to conform with a minimum size specification of the memory controller.

10. A parallel processing unit for compositing image surfaces to generate a display image for display, comprising:
a display engine configured to:
receive a first set of parameters associated with a first image surface stored in a memory;
receive a second set of parameters associated with a second image surface stored in the memory, wherein the second image surface overlaps at least a portion of the first image surface;
select a first pixel group that is associated with the first image surface and does not contribute visually to the display image; and
prevent the first pixel group from being retrieved from the first image surface.

11. The parallel processing unit of claim 10, wherein the display engine is further configured to:
scale the first image surface from a first source domain to a composition domain based on the first set of parameters; and
scale the second image surface from a second source domain to the first second composition domain based on the second set of parameters.

12. The parallel processing unit of claim 11, wherein the display engine is further configured to:
determine that the second image surface resides in front of the first image surface;
compute a cutout region for at least a portion of the composition domain that completely obscures one or more pixels within the portion of the first image surface; and
scale the cutout region from the composition domain to the first source domain.

13. The parallel processing unit of claim 12, wherein determining that the second image surface resides in front of the first image surface comprises determining that a first depth value associated with the first image surface is greater than a second depth value associated with the second image surface.

14. The parallel processing unit of claim 12, wherein the display engine is further configured to modify a dimension of the cutout region based on a scaling filter applied to the first image surface.

15. The parallel processing unit of claim 11, wherein the display engine is further configured to compute a cutout region for one or more pixels within the portion of the first image surface, wherein the one or more pixels are transparent.

16. The parallel processing unit of claim 10, wherein the first image surface is specified by a first device driver, and the second image surface is specified by a second device driver.

17. The parallel processing unit of claim 16, wherein the first device driver comprises a graphics display driver, and the second device driver comprises a video display driver.

18. The parallel processing unit of claim 10, wherein the display engine is further configured to:
align the first pixel group to conform with an alignment specification of a memory controller; and
size the first pixel group to conform with a minimum size specification of the memory controller.

19. A system, comprising:
a processor; and
a parallel processing unit that includes a display engine configured to:
receive a first set of parameters associated with a first image surface stored in a memory;
receive a second set of parameters associated with a second image surface stored in the memory, wherein the second image surface overlaps at least a portion of the first image surface;
select a first pixel group that is associated with the first image surface and does not contribute visually to the display image; and
prevent the first pixel group from being retrieved from the first image surface.

20. The system of claim 19, wherein the display engine is further configured to:
scale the first image surface from a first source domain to a composition domain based on the first set of parameters; and
scale the second image surface from a second source domain to the composition domain based on the second set of parameters.
